(19) United States
(12) Patent Application Publication
(10) Pub. No.: US 2022/0013926 A1
(43) Pub. Date: Jan. 13, 2022

(54) IMPROVED CABLE CONNECTOR

(71) Applicant: INDUSTRITEKNIK ROBI AB, FALUN (SE)

(72) Inventor: Leif CARLSSON, Falun (SE)

(73) Assignee: INDUSTRITEKNIK ROBI AB, FALUN (SE)

(21) Appl. No.: 17/294,614

(22) PCT Filed: Dec. 2, 2019
(86) PCT No.: PCT/SE2019/051216

§ 371 Date: May 17, 2021

(30) Foreign Application Priority Data
Dec. 21, 2018 (SE) 1851664-1

(51) Int. Cl. H01R 4/2406

(52) U.S. Cl. CPC H01R 4/2406

(57) ABSTRACT

A connector for an electrical cable comprising a base part and a pressure applying cap, said base part comprising a seat for receiving the electrical cable, the base part comprising a pair of lateral recesses for slidably receiving a pair of lateral projections on the pressure applying cap, each of the lateral recesses extending longitudinally along the base part at an angle with respect to the seat such that a region proximal a first end of the base is at a height H₁ from the seat, and a region of the recess distal the first end of the base part is at a height H₂, wherein, the height H₂ is less than the height H₁, and wherein the pressure applying cap is slidable with respect to the base part such that the force applied to the cable by the cap and the base part increases as the cap slides within the base part.

### FIELD OF THE INVENTION

The present disclosure relates to connectors for cables. In particular it relates to a connector comprising a base part and a pressure applying cap

### BACKGROUND OF THE INVENTION

Cable connectors and techniques for piercing cables are known. The standard IEC 60352-6: 1997 describes the requirements for insulation piercing connectors.

Such connectors should pierce with a reliable force.

However, connectors today require manual connection and are dependent on the force which may be applied by the user. As a user may be required to pierce many insulated cables during a day this results in ergonomic issues for users. Improved connectors which require less force, and are predictable in their force application to a cable are required.

U.S. Pat. No. 7,347,716 B2 describes a connector arrangement comprising a horizontal actuator plate comprising a wedge arrangement to pierce the cable. This connector is complex and comprises springs which actuate members inside the connector.

Simpler connectors which can be manufactured at low cost and with fewer moving parts would be ideal.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a connector for an electrical cable comprising a base part and a pressure applying cap, said base part comprising a seat for receiving the electrical cable, the base part comprising a pair of lateral recesses for slidable receiving a pair of lateral projections on the pressure applying cap, each of the lateral recesses extending longitudinally along the base part at an angle with respect to the seat such that a region proximal a first end of the base is at a height, H₁, from the seat, and a region of the recess distal the first end of the base part is at a height, H₂, wherein, the height H₂ is less than the height H₁, and wherein the pressure applying cap is slidable with respect to the base part such that the force applied to the cable by the cap and the base part increases as the cap slides within the base part.

A method for piercing an insulated cable is also provided.

An electrical assembly comprising a connector is also provided.

Furthermore, an operator device comprising a connector is provided.

Further advantageous embodiments are disclosed in the appended and dependent patent claims.

### BRIEF DESCRIPTION OF THE DRAWINGS

These and other aspects, features and advantages of which the invention is capable will be apparent and elucidated from the following description of embodiments of the present invention, reference being made to the accompanying drawings, in which

FIG. 1 is a perspective exploded view of the rear of a connector according to an aspect.

FIG. 2 is a perspective view of the rear of a connector according to an aspect.

FIG. 3 is a cross-sectional exploded perspective view of a connector according to an aspect.

FIG. 4 is a perspective view of a connector according to an aspect.

### DETAILED DESCRIPTION

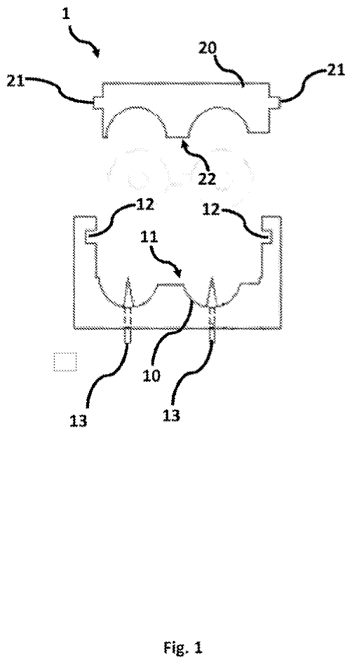

FIG. 1 shows a connector 1 for an electrical cable 3. The connector 1 comprises a base part 10, and a separate pressure applying cap 20. The base part 10 comprises a seat 11 for receiving an electrical cable 3. The base part 10 comprises a pair of lateral recess 12. The pressure applying cap 20 comprises a pair of lateral projections 21. The lateral recesses 12 of the base part 10 are for slidable receiving the pair of lateral projections 21 of the pressure applying cap 20. The pressure applying cap 20 is slidable with respect to the base part 10 such that the force applied to the cable 3 increases as the cap 20 slides within the base part 10. In such a manner the cable 3 is pierced by an at least one electrical pin 13, provided in the base part 10, with a pre-determined and repeatable force. Creating an electrical contact from the cable 3 to the at least one pin 13.

The base part 10 and the pressure applying cap 20 together form a connector 1 for an electrical cable 3. The connector 1 may house the terminus of the electrical cable 3. The lateral recess 12 and the lateral projections 21 are interconnecting, and at least partially interlocking. That is, the pressure applying cap 20 is held at the base part 10 via the operative connection of the lateral projections 21 and the lateral recesses 12.

The seat 11 of the base part 10 extends from a first end 14 of the base part 10, towards a second end 15 of the base part 10. The seat 11 may extend only partially through 10 the base part 10 such that the second end of the base part 10 is closed. The seat 11 may extend fully through the base part 10 such that the cable 3 may exit the base part 10 at the second end 15.

The pressure applying cap 20 comprises an upper seat 22 for the cable 3. The upper seat 22 is arranged in the bottom portion of the pressure applying cap. The upper seat 22 abuts the cable 3 when the pressure applying cap 20 is in place in the base part 10.

The seats 11, 22 may comprise a pair of semi-circular recesses connected by a central ridge. However, the seats may take a variety of forms provided they correspond to the form of the cable 3 to be pierced. The seats 11, 22 need not have the same form.

The lateral recesses 12 extend longitudinally along the base part 10 from a region proximal the first end 14 of the base part 10, to a region distal the first end 14 of the base part 10. The lateral recesses 12 extend at an angle with respect to the seat 11 along the length of the base 10. The recesses 12 extend at an angle such that the region proximal the first end 14 of the base 10 is at a height H1 from the seat. The region of the recesses 12 distal the first end 14 of the base part is at a height H2. The height H2 is less than the height H1. The height H2, may be 0, that is, it may be at the same height as the seat 11.

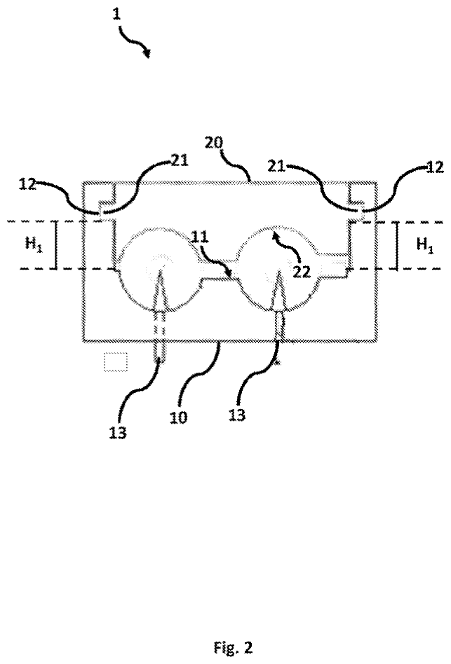

The lateral recesses 12 are formed by a continuous inward slot in the base part 10. Each of the pair of recesses 12 receives one of the lateral projections 21 of the pressure applying cap 20. The recesses 12 may be open at least one point along their length. By 30 open it is meant that the pair of recesses form a shoulder at which the pair of lateral projections 12 may abut and slide. The lateral recess 12 is at least partially closed along its length such that it forms a slot. The partially closed portion enables the pressure applying cap 20 to be held in place perpendicular to the longitudinal and lateral axes of the coupling. That is, in the arrangement shown in FIGS. 1 to 3, vertically. An opening allows the pressure applying cap 20 to be provided to the base part 10 from above. That is, it need not be slid from the first end 14 of the base part 10.

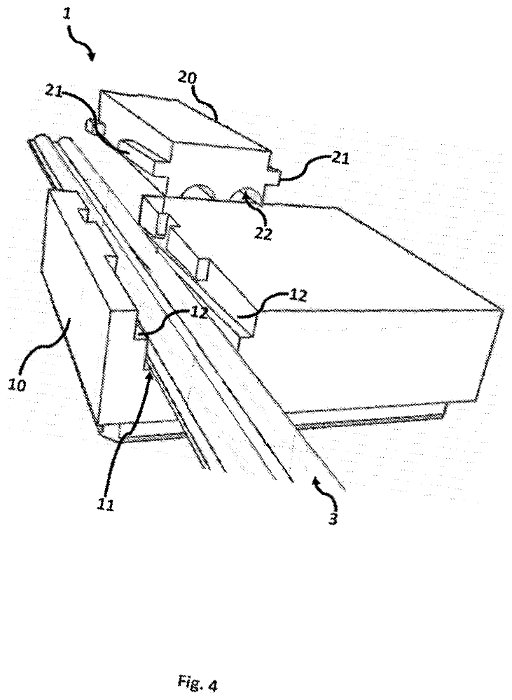

Each of the lateral projections 21 of the pressure applying cap 20 may be formed via a male member extending from the lateral walls of the pressure applying cap 20. The lateral projections 21 may have a rectangular cross-section along their length. The lateral projections 12 may be formed by a ridge extending laterally from the walls of the pressure 10 applying cap 20. The ridge may be continuous, or as shown in FIG. 4, it may be discontinuous. That is, the ridge may be formed by a plurality of ridge sections, the sections being spaced from each other.

The lateral projections 21 may be arranged at an angle corresponding to the angle of the lateral recesses 12. That is, the lateral projections 21 may be distal the upper seat 22 at a first end of the pressure applying cap 20, and proximal the upper seat 22 at a second end of the pressure applying cap 20.

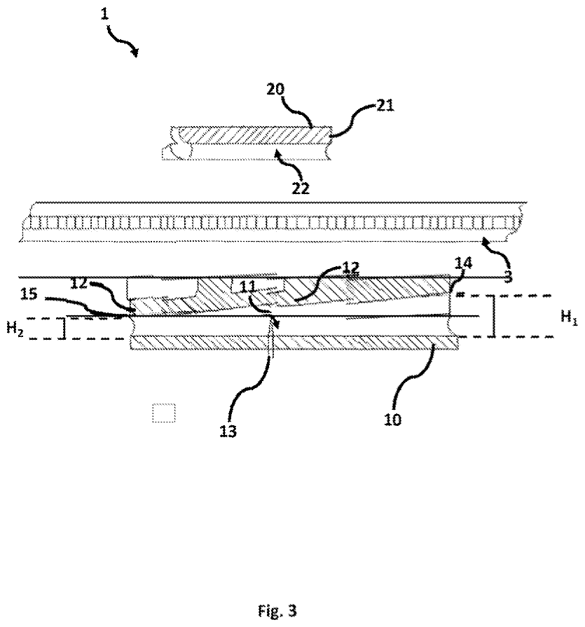

The lateral recesses 12 may be provided with openings at a plurality of points along their length. As shown in FIGS. 3 and 4, the lateral recesses 12 may comprise two openings. the pressure applying cap 20 may be provided with corresponding lateral projections 21 formed by a discontinuous ridge, or, each of the lateral projections may comprise a plurality of separate projections 21.

The pressure applying cap 20 may be provided to the base part 10 via lowering of the pressure applying cap 20 to the base part 10. Subsequently, the pressure applying cap 20 is slid with respect to the base part 10. During the sliding, the projections 21 mate with the corresponding recesses 12 and are held in place, with respect to the height of the base part 10, via the at least partially closed portion of the recesses 12.

The at least one pin 13 is a sharp, electrically conductive pin which extends in to the seat 11 of the base part 10. The at least one pin 13 may extend through the bottom of the base part 10 such that an electrical coupling may be made to the bottom of the pin 30 13.

The connector 1 described herein, and in particular the angle of the lateral recesses 12 results in the pressure applying cap 20 being forced at a predetermined and known rate towards the cable 3. The force applied to the cable 3 pierces any insulation on the cable 3 such that the at least one pin 13 contact the cable 3. The design of the connector 1 results in the cable 3 being pierced to a known depth every time.

The force applied to the pressure applying cap 20 is longitudinal, that is, it is in line with the lateral recess 12. Due to the arrangement of the recesses 12 and the projections 21, the pressure applying cap 20 applies the corresponding vertical force to the cable 3 sufficient to pierce the cable 3.

The connector may be provided to a push-button, switch, indicator, actuator or other device which may be used as an operator unit. Generally, a first portion of the device comprises the operator unit, such as the switch, a second portion of the device, typically, the rear of the device comprises the connector 1.

The connector 1 may be provided to an electrical assembly, such as an electrical cabinet. A plurality of connectors may be provided to an electrical assembly, each connector may receive the same electrical cable. That is, the connectors may be arranged in series.

Although, the present invention has been described above with reference to specific embodiments, it is not intended to be limited to the specific form set forth herein. Rather, the invention is limited only by the accompanying claims.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc. do not preclude a plurality. Reference signs in the claims are provided merely as a clarifying example and shall not be construed as limiting the scope of the claims in any way.

1-9. (canceled)

10. A connector for an electrical cable comprising a base part and a pressure applying cap,
said base part comprising a seat for receiving the electrical cable,
the base part comprising a pair of lateral recesses for slidably receiving a pair of lateral projections on the pressure applying cap,
each of the lateral recesses extending longitudinally along the base part at an angle with respect to the seat such that a region proximal a first end of the base is at a height H₁ from the seat, and a region of the recess distal the first end of the base part is at a height H₂, wherein, the height H₂ is less than the height H₁, and wherein the pressure applying cap is slidable with respect to the base part such that the force applied to the cable by the cap and the base part increases as the cap slides within the base part.

11. The connector according to claim 10, wherein the pressure applying cap comprises an upper seat and wherein the lateral projections are distal the upper seat at a first end of the pressure applying cap, and proximal the upper seat at a second end of the pressure applying cap, such that the angle of each of the projections corresponds to the angle of each of the recesses.

12. The connector according to any of claim 10, wherein each of the lateral recesses comprises at least one open portion forming a shoulder for the projection, and at least one closed portion for holding the pressure applying cap in place.

13. The connector according to claim 10, wherein the connector comprises at least one pin for piercing the cable.

14. The connector according to claim 13, wherein the pin extends at least partially into the seat.

15. The connector according to claim 10, wherein the projections are formed by a plurality of discontinuous ridges extending laterally from the walls of the pressure applying cap.

16. The connector according to claim 10, wherein the connector is comprised in an operator device, such as a push-button, switch and/or indicator, and wherein a first part of the operator device comprises the operator unit, such as a switch and wherein a second part of the operator device comprises the connector.

17. A method for piercing an insulated cable comprising:
providing the cable to the seat of a base portion of a connector according to claim 13, providing a pressure applying cap of the connector to the base portion,
sliding the pressure applying cap with respect to the base portion such that the force applied to the cable causes the insulation to be pierced by the at least one pin provided in the seat of the base portion.

18. An electrical assembly comprising a plurality of connectors according to claim 10, each of the plurality of connectors for receiving the same electrical cable.
